(19) United States
(12) Patent Application Publication
(10) Pub. No.: US 2008/0234533 A1
(43) Pub. Date: Sep. 25, 2008

(54) System for evaluating an environment

(75) Inventor: Steven Hoard Vollum, Hillsboro, OR (US)

Correspondence Address: CHERNOFF, VILHAUER, MCCLUNG & STENZEL, 1600 ODS TOWER, 601 SW SECOND AVENUE, PORTLAND, OR, 97204-3157, US

(73) Assignee: Precision Innovations LLC

(21) Appl. No.: 11/726,450

(22) Filed: Mar. 21, 2007

(51) Int. Cl. G01C 25/00

(52) U.S. Cl. 600/9; 33/355 R; 73/1.75

(57) ABSTRACT

An environmental evaluation device and system enables determination of the ambit and orientation of an environment and the favorability of the environment for an individual according to principles of feng shui.

### CROSS-REFERENCE TO RELATED APPLICATIONS

Not applicable.

### BACKGROUND OF THE INVENTION

The present invention relates to a system for evaluating an environment and, more particularly, to a method and apparatus for measuring and analyzing the size, orientation and arrangement of an environment and the favorability of the environment for an individual.

Evaluating an environment, such as a room, a dwelling, a yard or a potential building site is important to a number of professions and individuals. By way of example, the layout and square footage of a building or a tract of land is an important metric to a potential purchaser and, therefore, a real estate professional. Similarly, the size, orientation and shape of a tract and the locations of plants, structures and other objects are important to a landscape architect's planning. The size of a room and the orientation of windows and doors is important to an interior designer seeking to locate furniture or other objects in a home or office. In addition, many individuals and, as a result, many professionals have an interest in the principals of feng shui, an ancient Chinese practice combining geographic, religious, philosophical, mathematical, aesthetic and astrological factors to determine a placement and arrangement of space to achieve harmony in one's life. The goal of feng shui is to locate and orient dwellings, possessions, landscaping and other elements of an environment so that the environment is attuned to the flow of qi, a life energy that flows within air (wind) and water, appropriate for a particular individual.

What is desired, therefore, is an environmental evaluation system that enables a user to define and evaluate an environment.

### BRIEF DESCRIPTION OF THE DRAWINGS

FIG. 1 is a top view of an exemplary environmental evaluation device.

FIG. 2 is a block diagram of an exemplary environmental evaluation system.

FIG. 3 is a flow diagram of an exemplary method of determining a compass direction and a favorability of an environment.

FIG. 4 is a partial perspective illustration of the use of a target illuminator in orienting an environmental evaluation device.

FIG. 5 is a schematic view of an exemplary environment.

FIG. 6 is a flow diagram of a method of determining a layout and an area of an environment.

### DETAILED DESCRIPTION OF PREFERRED EMBODIMENTS

The environmental evaluation system enables a user to capture the position and orientation of features and objects that define an environment, such as a room or a building location. From data defining the ambit and the orientation of the environment, the environmental evaluation system can determine the layout, size and orientation of the environment and, based on the principles of feng shui, the auspiciousness or favorability of the environment for an individual.

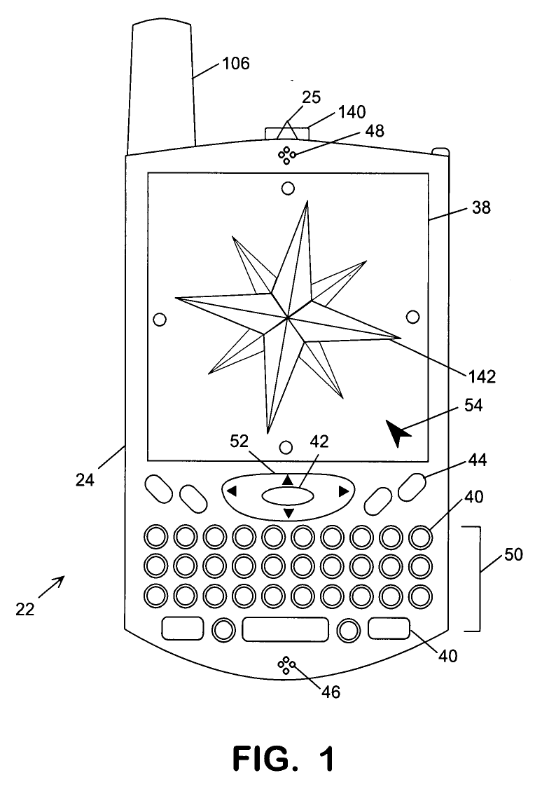

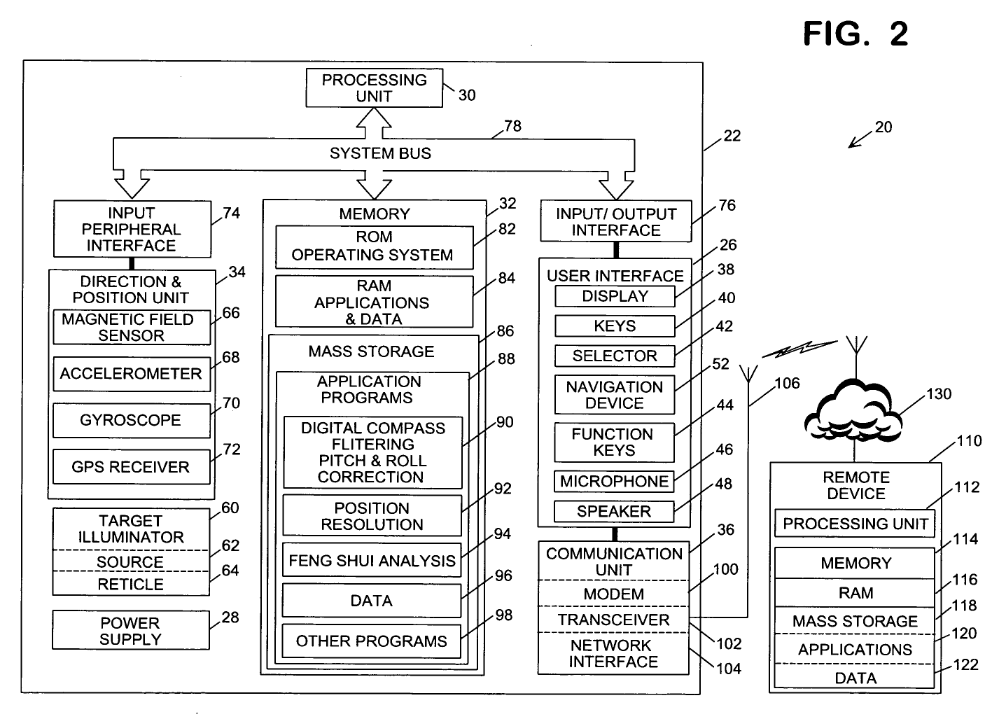

Referring in detail to the drawings where similar parts of the environmental evaluation system are identified by like reference numerals, and, more particularly to FIGS. 1 and 2, an exemplary system for evaluating an environment 20 includes an environmental evaluation device 22 that comprises a data processing system. Examples of well known data processing systems and/or configurations that may be suitable for use with the environmental evaluation system include, but are not limited to, personal computers (PCs), server computers, hand-held or laptop devices, multiprocessor systems, microprocessor-based systems, programmable consumer electronic devices, personal digital assistants (PDAs), mobile communication devices, network PCs, minicomputers, mainframe computers, and distributed computing environments that include any of the above systems or devices, and the like. The exemplary environmental evaluation device 22 comprises a handheld, portable data processing system contained in a case 24 providing a platform that enables the environmental evaluation system to be easily transported to and within a location that is to be evaluated. The data processing system typically includes a user interface 26, a power supply 28, a processing unit 30, a memory 32, a direction and position sensing unit 34 and a communications unit 36 enabling communication with other remotely located data processing devices.

The user interface commonly includes a display 38 for visually presenting output to the user. Many mobile data processing devices include a liquid crystal display (LCD) in which portions of a layer of dichromatic liquid crystals can be selectively, electro-magnetically switched to block or transmit polarized light. Another type of display comprises organic light emitting diodes (OLED) in which cells comprising a stack of organic layers are sandwiched between a transparent anode and a metallic cathode. When a voltage is applied to the anode and cathode of a cell, injected positive and negative charges recombine in an emissive layer to produce light through electro-luminescence. OLED displays are thinner, lighter, faster, cheaper, and require less power than LCD displays. Another emerging display technology for mobile data processing devices is the polymer light emission diode (PLED). PLED displays are created by sandwiching a polymer between two electrodes. The polymer emits light when exposed to a voltage applied to the electrodes. PLEDs enable thin, full-spectrum color displays that are relatively inexpensive compared to other display technologies, such as LCD or OLED, and which require little power to produce a substantial amount of light. The displays types listed above are by way of example only and any method or device useful for visually presenting information to a human user may be used in conjunction with the environmental evaluation device.

The user interface of the exemplary environmental evaluation device 22 also includes one or more user input devices. For example, the exemplary environmental evaluation device includes a keyboard 50 (indicated by a bracket) comprising a plurality of user operable keys 40 for inputting text and performing other data processing activities. In addition, the user interface of the environmental evaluation device may include a plurality of function keys 44 that facilitate selecting and operating certain features or applications installed on the device, such as a wireless telephony or electronic messaging. The keys of the user interface, including the function keys, may be programmable to perform different functions during the operation of respective application programs installed on the device. For example, when the operation of the environmental evaluation system is invoked certain function keys may become operable to control a target illuminator 60 or to cause data collection from one or more of the sensors of the device's direction and position sensing unit 34.

The user interface of the exemplary environmental evaluation device also includes a navigation button 52 that facilitates movement of a displayed pointer 54 for tasks such as scrolling through displayed icons, menus, lists, and text. In other devices the functions of the navigation button may be performed by a mouse, joy stick, or touch pad. The navigation button 52 includes a selector button 42 permitting displayed objects and text to be selected or activated in a manner analogous to the operation of a mouse button.

Further, the display 38 of the exemplary environmental evaluation device may comprise a touch screen permitting the user to make inputs to the data processing system by touching the display with a stylus or other tactile device. A touch screen enables the user to select application programs and input commands to the data processing system by touching the screen at points designated by displayed menu entries and icons. The environmental evaluation device may also include a handwriting recognition application program that converts characters, drawn on the touch screen display with a tactile device or stylus, to letters or numbers.

The exemplary environmental evaluation device also includes a microphone 46. The microphone converts the pressure fluctuations comprising sound, including speech, to an analog signal which is converted to digital data by an analog-to-digital converter (ADC) in an input-output interface 76 that connects the elements of the user interface to an internal system bus 78. The microphone may be built into the case of the device, as illustrated, or may be separate from the case and connected to the device by a wired or a wireless communication link. Audio output is provided by a speaker 48 or a separate earpiece that is communicatively connected to the device by a wired or a wireless communication link. Digital data is converted to an analog signal by a digital-to-analog converter (DAC) of the input-output interface and the speaker converts the analog signal to sound. The microphone and speaker provide audio input and output, respectively, when using a wireless telephone or when recording an oral annotation for the environmental evaluation system and, in conjunction with a voice recognition application program can enable a user to control the operation of the environmental evaluation device and programs installed on the environmental evaluation device with verbal commands.

The data processing functions of the environmental evaluation system are performed by a processing unit 30 which typically comprises one or more microprocessors. A user can input data and commands to the processing unit with the various input devices of the user interface, including the selector button 42, keyboard 50, function keys 44, and a touch screen display. The processing unit also captures data from one or more sensors of the direction and position sensing unit 34, fetches data and instructions from a memory 32 or the user interface, processes the data according to the program instructions, and stores or transmits the result. The digital output of the processing unit may be used to activate an input device, such as one of the sensors, or to operate an output device, for example, the digital output may be converted to analog signals by the DAC of the input-output interface to enable audio output from the speaker or transmitted by the input/output interface to a peripheral device, such as a printer or a scanner.

On the other hand, the output of the processing unit may be transmitted to a remote computer 110. The remote computer may be a personal computer, a server, a router, a network PC, a peer device or other common network node, and typically includes many or all of the elements of the exemplary environmental evaluation device, described above, including a processing unit 112 and a memory 114 including RAM 116 and mass storage 128 for application programs 120 and data 122. The remote device may perform any of functions of the environmental evaluation system using data collected and transmitted to the remote device by the environmental evaluation device.

The environmental evaluation device 22 typically includes a communications unit 36 that enables data to be transferred to and from a remote computer. The environmental evaluation device may be equipped to communicate with a remote computer by way of a communication network, such as a local area network (LAN) or wide area network (WAN), commonly including the Internet and the World Wide Web 130. When used in a LAN networking environment, the environmental evaluation system is connectable to the LAN through a network interface or adapter 104 of the communications unit. When used in a WAN networking environment, the communication unit typically includes a modem 100 or other means of establishing communication over the WAN, and commonly includes at least one of an infrared light or radio frequency transceiver 102 for transmitting and receiving communication signals. The exemplary environmental evaluation device comprises a radio frequency transceiver and an antenna 106. The communication unit may be internal or external to the case of the environmental evaluation device and may be connected to the system bus 78 via the user input-output interface 76 or another appropriate mechanism. In a networked environment, programs or program modules that are depicted as stored in the memory of the environmental evaluation device 22 may be stored and operable on the remote computer 110 and data captured by the environmental evaluation device may be transmitted from the device to the remote computer for processing and analysis.

Program instructions and data used by the processing unit are stored in a memory 32. Typically, the operating system, the basic operating instructions used by the processing unit, is stored in a nonvolatile memory, such as read only memory (ROM) 82 or flash memory. Application programs 88, including applications related to environment evaluation and other programs 98, and data 96 used by the processing unit are typically stored in a mass storage portion 86 of the memory. The mass storage may be built-in to the environmental evaluation device and may comprise static random access memory (SRAM), flash memory, optical disk drive, a magnetic hard drive or other form of computer accessible data storage. On the other hand, the mass storage may be a form of removable, non-volatile memory, such as flash memory cards; disk storage, such as a floppy disk, compact disk (CD), digital versatile disk (DVD), USB flash drive, or another removable media device. The data and program instructions are typically transferred from the mass storage portion of the memory to a random access memory (RAM) 84 portion and fetched from RAM by the processing unit for execution. However, in some handheld portable data processing systems the mass storage may function as RAM with the data and instructions fetched directly from and stored directly in the mass storage. Data and instructions are typically transferred to and from the processing unit over the internal system bus 78.

The environmental evaluation device includes a power supply 28, which, in a handheld portable data processing system, typically includes a battery and regulating circuitry. The battery may be removable for recharging or replacement or the power supply may include recharging circuitry to permit the battery to be recharged in the device. Integrating the recharging circuitry typically permits the data processing system to be powered by an external power source, such as utility supplied, AC power.

The environmental evaluation system also comprises a direction and position sensing unit 34 comprising a plurality of sensors to detect the position and orientation of the environmental evaluation device and one or more application programs including a digital compass program 90 and a position resolution program 92, that include program instructions that enable the processing unit to determine, from data output by the sensors, the location and orientation of the environmental evaluation device and from such information the location, orientation and layout of an environment and objects within the environment. In addition, the environmental evaluation system includes a feng shui analysis program 94 including program instructions that enable the processing unit to analyze of the auspiciousness or favorability of the environment for an individual using the principles of feng shui.

Feng shui is a Chinese belief system mixing geographic, religious, philosophical, mathematical, aesthetic and astrological concepts related to placement and arrangement of space to achieve harmony with the environment. The definitive tool for feng shui practitioners is an accurate compass, known as the luo pan. The traditional Chinese luo pan is a disk, inscribed with sixteen or more concentric circles that are subdivided by radial divisions and marked with appropriate characters. An accurate magnetic compass occupies the center of the disk. The disk synthesizes the Chinese theories of cosmic harmony between the energies of nature; time, as indicated by the sun and moon; and the directions in space from a point on the earth. An individual's harmony with the environment is believed to be significantly and profoundly effected by the individual's orientation in the environment.

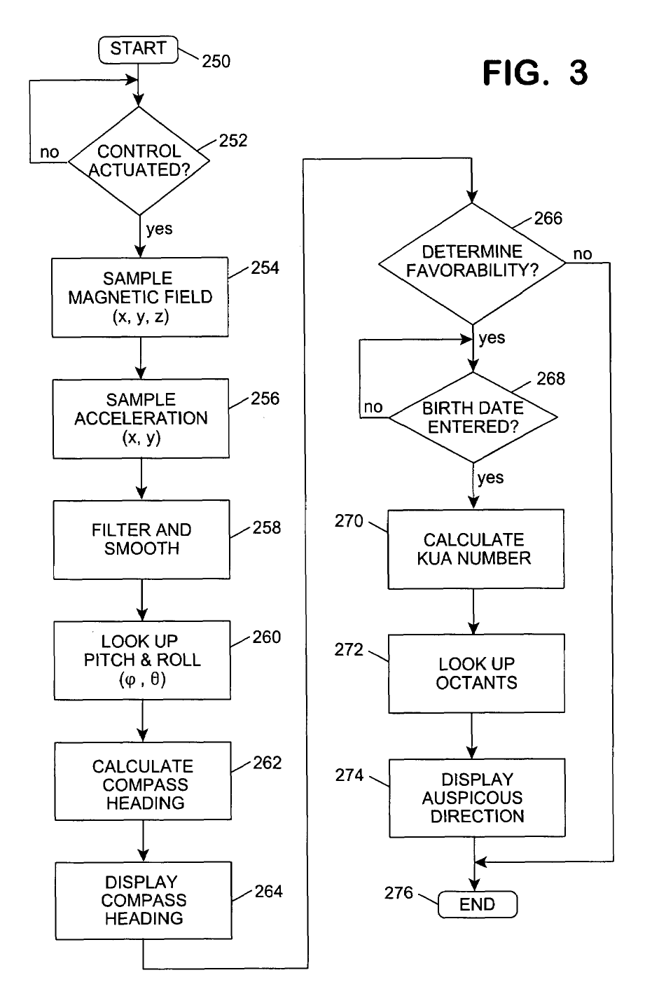

The environmental evaluation system performs the functions of a luo pan in determining a compass direction or heading to a feature of the environment and the favorability of the environment for an individual. Referring to FIG. 3, to determine the compass direction for a feature of an environment, for example, the center of the main wall of a building or a door of a room, relative to a user's location in the environment, the user initiates 250 the digital compass application 90 and points the environmental evaluation device in the direction normal to the feature. The exemplary environmental evaluation device includes a pointer 25 affixed relative to the case to aid the user in aiming the device. When the user activates the appropriate control 252, for example one of the function keys of the user interface, the processing unit of the environmental evaluation device samples 254 the outputs of a three-axis magnetic field sensor 66, preferably a magnetometer sensing the strength of the earth's magnetic field in three mutually perpendicular directions, and the outputs 256 of a two-axis (x,y) accelerometer 66 of the direction and position sensing unit.

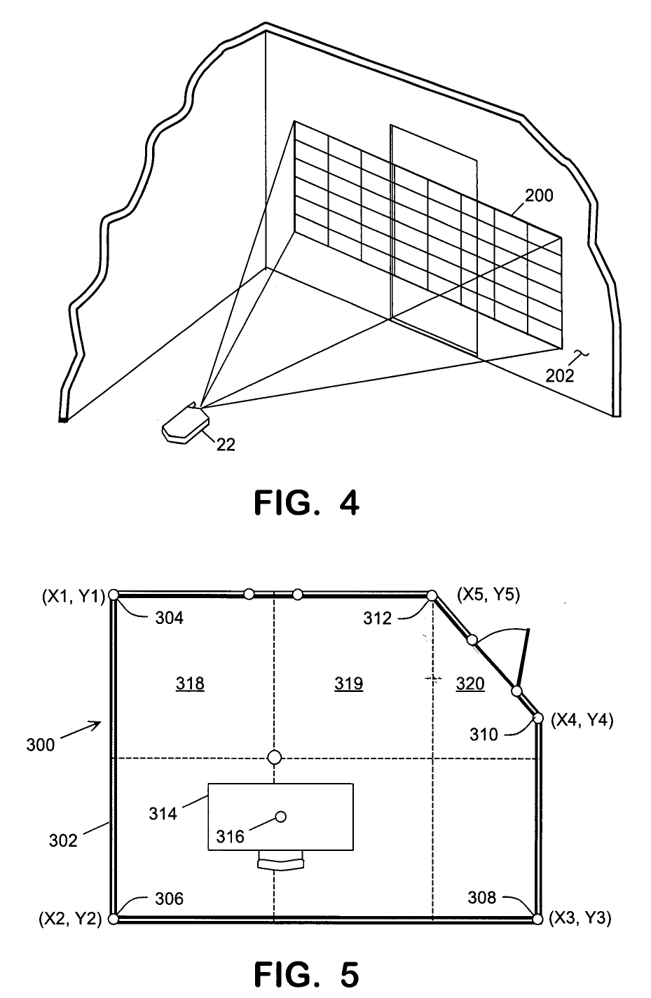

Accurate compass readings are important for feng shui interpretations and a compass that is accurate to at least one degree, with a resolution of 0.5 degrees, is highly desirable. To aid the user in accurately aiming the environmental evaluation device, the device includes a target illuminator 60. The target illuminator may comprise a focused light source, such as a laser pointer, to enable the user to align the axis of the environmental evaluation device and the sensors of the position and direction unit with a target, such as a feature of the environment. Referring also to FIG. 4, preferably, the target illuminator comprises a light source 62, such as a light emitting diode (LED), having an output that propagates through a lens 140 and reticle 64 to display a grid 200 or other pattern of varying intensity on a surface 202 of the environment. Feng shui analysis commonly relies on determination of the direction to the center of an environmental surface, such as the center of a main wall of a building or a room, and the projected grid or pattern aids the user in accurately locating and aligning the environmental evaluation device with the center of an environmental feature, improving the accuracy of a compass reading.

To provide the accurate compass headings desired for feng shui interpretations, the environmental evaluation system preferably utilizes the third axis output of the magnetic field sensor and the outputs of the two-axis accelerometer to correct for misalignment of the environmental evaluation device with earth's magnetic field. When the user activates the appropriate user interface control, the outputs of the magnetic field sensors 66 and the accelerometers 68 are sampled and digitized 254, 256. The digitized outputs are smoothed and filtered 258 by the processing unit utilizing filtering program instructions of the digital compass program 90 stored in the memory.

The compass heading is determined from the measured values of the magnetic field in the x and y axis as detected by the magnetic field sensor and as corrected for the tilt, pitch and roll of the environmental evaluation device when the magnetic field was sampled. The compass heading equals:

c=arctangent (Y′/X′) (1)

where:
c=the compass heading;
Y′=corrected y-axis magnetic field vector;
X′=corrected x-axis magnetic field vector.
   The tilt of the device is sensed in each axis by the output of the z-axis portion of the magnetic field sensor and the accelerometers and converted to one or more gravitational values. The gravitational values are compared to a table specifying the relationship of gravitational values and tilt or misalignment angle of the environmental evaluation device 260. The tilt compensated magnetic field vectors, X′ and Y′, equal:

X′=X cos(φ)+Y sin(θ)sin(φ)−Z cos(θ) sin(φ) (2)

Y′=Y cos(θ)+Z sin(θ) (3)

where:
X=measured x-axis magnetic field vector
Y=measured y-axis magnetic field vector
Z=measured z-axis magnetic field vector
φ=pitch angle from accelerometer output
θ=roll angle from accelerometer output
   The compass heading is computed 262 from the measured outputs of the magnetic field sensor and the accelerometers and is displayable 264 on the user interface of the environmental evaluation device.

With the compass direction to a certain feature of the environment, such as the center of the main wall or a door of a room, and information about an individual, which can be entered into the environmental evaluation device's memory with the devices of the user interface, the user of the environmental evaluation system can perform a feng shui evaluation of the favorability of the environment for the individual 266.

Feng shui divides the 360° of the compass circle into octants (45°) which are, in turn, each divided into three 15° segments called mountains. Each mountain is labeled with its compass octant, for example, east (E) followed by the numeral 1, 2, or 3. The central mountain, mountain 2, is centered on the cardinal direction and extends 7.5° on either side of the cardinal direction. For example, the mountain E2 is centered on the cardinal direction EAST (90°) and extends between 82.5° and 97.5°. The mountains E1 and E3 are disposed on either side of the center mountain, E2. From the compass heading (c), the corresponding mountain (Mn) can be determined from:

Mn=3+integer(c−(octant*45−22.5)/15) (4)

where
Mn=mountain
c=compass heading in degrees

octant=(((integer)c/22.5)+1)/2)MODULO 8 (5)

According to feng shui teachings, each individual has a kua number which is determined by the person's sex and birth year and four compass octants are favorable and four octants are unfavorable for individuals having a particular kua number.

For males the kua number (kₘ) is determined by repeatedly summing the last two digits of the individual's birth year until the result is less than 10 and then subtracting the result from 10. For purposes of determining the kua number, an individual's birth year is determined from the Chinese lunar calendar, so if an individual's birth date occurs before February 6, the birth year, according to the Georgian calendar, is reduced by one. For example, a male born in January 1955 would have birth year of 1954 would have a kua number, kₘ, of one:

5+4=9; 9<10

kₘ=10−(5+4)=10−9=1 (6)

For females the kua number (k_{f}) is obtained by repeatedly summing the last two digits of the individual's birth year until the result is less than ten and then adding five to the result. For example, a female born in 1957 would have kua number, k_{f}, of eight:

5+7=12; 12>10; 1+2=3; 3<10

k_{f}=1+2+5=3+5=8 (7)

To determine the favorability of an environment for an individual according to the principles of feng shui, the user enters the individual's sex and birth year 268 into the environmental evaluation device with the appropriate user interface controls. The environmental evaluation device calculates the kua number and references a stored table to determine the favorable and unfavorable compass octants 272. The compass octant represented by the compass heading is compared to the favorable and unfavorable octants of the individual and the auspiciousness of the environment as oriented is displayed for the user 274 completing the analysis 276. Appropriate symbols denoting the auspiciousness of the environment may be displayed by the environmental evaluation device, including a symbol 142 indicating the difference between the current compass heading and a favorable direction. Likewise, by entering the sex and birth date of an individual through user interface of the environmental evaluation device, the device can display favorable and unfavorable compass headings for the individual and the difference or error between a favorable compass heading and the current compass heading of the device.

To evaluate the size and layout of an environment, such as a room, a building or a tract of land, the relative coordinates of a plurality of points defining the ambit of the environment are captured with the environmental evaluation system. Referring to FIG. 5, for example, the floor of an exemplary room 300 is bounded by the room's walls 302 which are defined by the coordinates of a plurality of wall intersections 304, 306, 308, 310, 312. The ambit of the room is established by successively locating the environmental evaluation device at each of a plurality of points along the periphery of the environment, preferably at each of the wall intersections, and recording the relative coordinates of the respective locations.

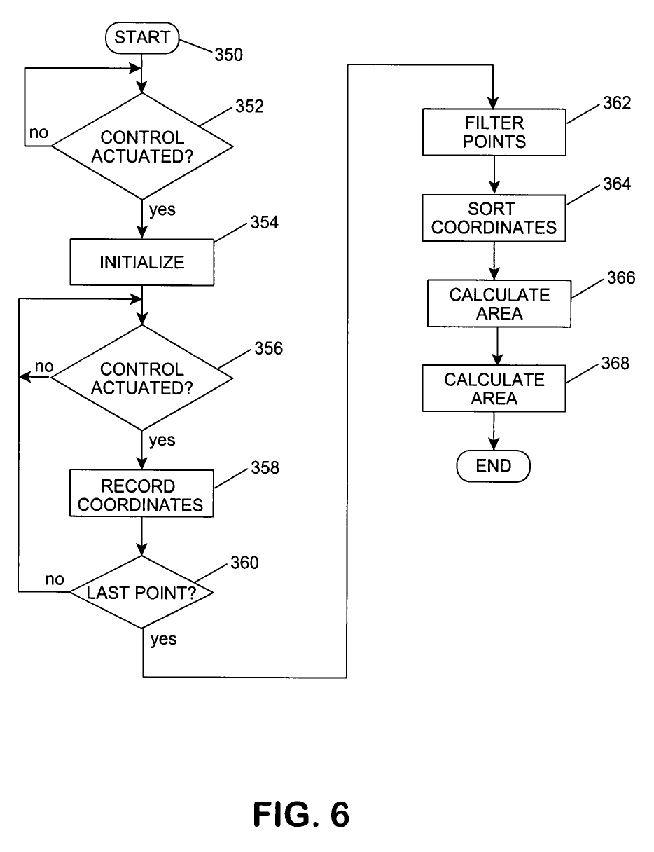

Referring also to FIG. 6, the user of the environmental evaluation device starts the size and layout evaluation by initiating 350 the position resolution application program 92 stored in the memory of the environmental evaluation device. The user positions the environmental evaluation device 22 at an initial point on the periphery of the environment, for example, the wall intersection (X1, Y1) 304. When the user activates the appropriate control on the user interface 352, the processing unit 30 initializes 354, at least, the outputs of a gyroscope 70 and the accelerometers 68 comprising an inertial measurement portion of the direction and position sensing unit 34. In addition, an initial position of a global positioning system (GPS) receiver 72 may be established by the processing unit and the outputs of the magnetic field sensors 66 may be sampled.

The environmental evaluation system typically includes a GPS receiver or an assisted global positioning (AGPS) receiver 72 to enable the geographic location of the data processing device to be determined. The global positioning system comprises a constellation of, at least, 24 satellites orbiting the earth every twelve hours in circular orbits, a plurality of ground-based monitoring stations, a control station and a GPS receiver. Four of the satellites orbit in each of six orbital planes with the orbits aligned so that at least four satellites are continuously within line of sight of any place on Earth. The GPS satellites broadcast navigation signals comprising a 37,500 bit navigation message including an almanac, providing coarse time and status information, and an ephemeris comprising orbital information that enables the receiver to calculate the position of the satellite. In addition, the satellites broadcast clock information comprising a code acquisition code and a phase code (P code).

A GPS receiver determines its geographic position by calculating its distance from each of the GPS satellites within line of sight of the receiver. When the receiver receives the code acquisition signal from a satellite, the satellite is identified from the unique pattern of the code acquisition sequence. The distance to the satellite is calculated by measuring the time delay between transmission of the code acquisition signal by a satellite and receipt of the signal by the receiver. The receiver calculates the time delay for the transmission from the satellite by producing a code sequence identical to the code acquisition sequence received from the satellite and by comparing the locally produced sequence to the sequence received from the satellite as a delay in comparing the sequences is increased. When the two signals match, the delay experienced by the local sequence is equal to the time that is required for the transmitted sequence to reach the receiver. From the delay, typically 65-85 milliseconds, and the data in the ephemeris, a pseudorange, the distance between the receiver and the satellite, is calculated. By determining the simultaneous position of four satellites and their respective distances from the receiver, the geographic location of the receiver can be determined.

Assisted GPS (AGPS) describes a system in which the GPS receiver is assisted in determining range and position measurements by an outside assistance server and reference network. The assistance server has the ability to access information from a reference network, for example a cellular telephone network, and to communicate with the GPS receiver. A stand-alone GPS receiver must search for satellite signals and decode the satellite navigation messages before computing its position, tasks which require strong signals and additional processing time. An assistance server can obtain an initial approximate position of the receiver and the decoded satellite ephemeris and clock information for a cellular telephone network. With additional computing power and the additional information obtained from the network, the AGPS system, the AGPS receiver can utilize weaker signals and determine its position more quickly than a standalone receiver. The environmental evaluation system may utilizes a global positioning system to establish a geographic position of an environment and may utilize the global positioning system to correct for drift of the inertial measurement portion of direction and position sensing unit. However, determination of the ambit of an environment is preferably determined from inertial measurements, the outputs of the gyroscope and the accelerometers, because signals from the global positioning system very commonly cannot be received while indoors.

When the environmental evaluation device is moved the processing unit 30 detects the acceleration and rate of change in the attitude of the device from the outputs of the gyroscope and the accelerometers. When the environmental evaluation device reaches the next user selected location, for example, the wall intersection (X2, Y2) 306, the user activates the appropriate input device of the user interface 356 and the processing unit computes coordinates of the new location 358, relative to the prior location. The output of the magnetic field sensor 66 may be used to provide additional confirmation of the direction of movement and to correct for drift in the inertial measurements. In addition, if access to GPS signals are not blocked by a structure or other obstruction, the processing unit will record the output of the GPS receiver providing geographic coordinates of the selected location. The additional input is useful in correcting for drift in the inertial measurement, enabling improved accuracy. The coordinates of the new location of the environmental evaluation device are recorded and the user moves the device to the next location, and records its coordinates. The operation is repeated until the ambit of the space has been enclosed by sampling locations and the user indicates that the last point has been selected 360.

The set of coordinates for the ambit of the environment are filtered 362 to eliminate redundant coordinates, coordinates of intermediate locations, such as windows and doors, and coordinates of locations not on the tract's boundary to reduce the complexity of the layout and area determination. At step 364, the coordinate set is sorted into an ordered set of coordinates defining the periphery of the environment, beginning at an initial point and progressing in one direction around the periphery until the initial point is reached again. By graphically representing connections between the coordinates of the sampled locations, a plot of the periphery of the environment, including the compass alignment of the environment, can be graphically constructed for viewing on the display or printing 366. Coordinates defining objects in the environment, for example, a desk 314, and its position 316 can be similarly established and graphically superimposed on the graphical representation of the environment for presentation to a user.

The area of the tract is computed 368 from the ordered set of coordinates using, for example, Green's theorem which states that the area of a bounded space equals one-half of the determinant of a 2×n element matrix comprising the coordinates of (n) points that define the boundary of the tract:

$$Area = 1 / 2 \vert \begin{matrix}X 1 & Y 1 \\ X 2 & Y 2 \\ X 3 & Y 3 \\ ⋯ & ⋯ \\ X n & Y n \\ X 1 & Y 1\end{matrix} \vert \qquad ( 7 )$$

Expressed algebraically, the area equals:

Area=½[(X1Y2+X2Y3+X3Y4+ . . . +XnY1)−(Y1X2+Y2X3+Y3X4+ . . . +YnX1)] (8)

where XnYn=x and y coordinates of locations on the periphery of the space

If desired, a environment can be divided into a plurality of regions, for example regions 318, 319, 320, etc., and the area of the environment calculated by summing the areas of each of the regions.

The environmental evaluation system enables the position, orientation and ambit of an environment to be established and the auspiciousness of the environment to be evaluated according to the principles of feng shui.

The detailed description, above, sets forth numerous specific details to provide a thorough understanding of the present invention. However, those skilled in the art will appreciate that the present invention may be practiced without these specific details. In other instances, well known methods, procedures, components, and circuitry have not been described in detail to avoid obscuring the present invention.

All the references cited herein are incorporated by reference.

The terms and expressions that have been employed in the foregoing specification are used as terms of description and not of limitation, and there is no intention, in the use of such terms and expressions, of excluding equivalents of the features shown and described or portions thereof, it being recognized that the scope of the invention is defined and limited only by the claims that follow.

I (we) claim:

1. A system for evaluating an environment, said system comprising:
(a) a first magnetic field sensor to sense a first component of a magnetic field in a first direction;
(b) a second magnetic field sensor to sense a second component of said magnetic field in a second direction normal to said first direction;
(c) a third magnetic field sensor to sense a third component of said magnetic field in a third direction normal to said first and said second directions;
(d) a first accelerometer to sense a first acceleration in said first direction;
(e) a second accelerometer to sense a second acceleration in said second direction; and
(f) a processing unit responsive to a program instruction to measure said first, said second and said third components of said magnetic field, said first acceleration, and said second acceleration and determine a compass direction from said measured components of said magnetic field and said measured acceleration.

2. The system for evaluating an environment of claim 1 further comprising:
(a) a user input device enabling a user to input a birth date to said processing unit;
(b) a program instruction executable by said processing unit to determine a favorability of said compass direction according to a principle of feng shui for an individual having said birth date; and
(c) a display enabling display of a metric of said favorability of said direction.

3. A system for evaluating an environment comprising:
(a) a position sensing unit capable of sensing a direction and a distance when said position sensing unit is moved from a location to another location; and
(b) a processing unit responsive to a program instruction to record an output of said position sensing unit when said position sensing unit moved from a first location to a second location and when said position sensing unit is moved from said second location to a third location and to determine an ambit of a tract defined by said first, said second and said third locations.

4. The system for evaluating an environment of claim 3 further comprising a program instruction executable by said processing unit to enable determination of an area of said tract.

5. The system for evaluating an environment of claim 3 wherein said position sensing unit comprises:
(a) a gyroscope responsive to movement to output a direction signal indicating a direction of said movement; and
(b) a first accelerometer responsive to a change in velocity to output a first acceleration signal indicating a change in velocity in a first direction;
(c) a second accelerometer responsive to a change in velocity to output a second acceleration signal indicating a change in velocity in a second direction; and
(d) a program instruction executable by said processing unit to:
(i) in response to a first user input, initiate input of said direction signal, said first acceleration signal and second acceleration signal to said processing unit;
(ii) in response to a second user input, terminate input of said direction signal, said first acceleration signal and said second acceleration signal to said processing unit; and
(iii) determine displacement of said position sensing unit in said first direction and said second direction from said direction signal, said first acceleration signal and said second acceleration input to said processing unit.

6. The system for evaluating an environment of claim 5 further comprising a program instruction executable by said processing unit to enable determination of an area of said tract.

7. The system for evaluating an environment of claim 5 further comprising:
(a) a first magnetic field sensor to sense a first component of a magnetic field in a first direction;
(b) a second magnetic field sensor to sense a second component of said magnetic field in a second direction normal to said first direction;
(c) a third magnetic field sensor to sense a third component of said magnetic field in a third direction normal to said first and said second directions; and
(d) a program instruction enabling said processing unit to modify at least one of said displacement in said first direction and said displacement in said second direction in response to a measurement of at least one said first, said second and said third components of said magnetic field.

8. The system for evaluating an environment of claim 7 further comprising a program instruction executable by said processing unit to enable determination of an area of said tract.

9. The system for evaluating an environment of claim 5 further comprising:
(a) a receiver for a global positioning signal; and
(b) a program instruction enabling said processing unit to determine a global position of said position sensing unit and to modify at least one of said displacement in said first direction and said displacement in said second direction in response to determination of said global position when input of said direction signal is at least one of initiated and terminated.

10. The system for evaluating an environment of claim 9 further comprising a program instruction executable by said processing unit to enable determination of an area of said tract.

11. An apparatus for evaluating an environment, said apparatus comprising:
(a) a first magnetic field sensor outputting a first magnetic field datum in response to a component of a magnetic field acting in a first direction;
(b) a second magnetic field sensor outputting a second magnetic field datum in response to a component of said magnetic field acting in a second direction normal to said first direction;
(c) a third magnetic field sensor outputting a third magnetic field datum in response to a component of said magnetic field acting in a third direction normal to said first direction and said second direction;
(d) a first accelerometer outputting a first acceleration datum in response to acceleration in said first direction;
(e) a second accelerometer outputting a second acceleration datum in response to acceleration in said second direction;
(f) a memory arranged to store a program instruction and a datum; and
(g) a processing unit responsive a program instruction to determine a compass direction from said first, second and third magnetic field data and said first acceleration datum and said second acceleration datum.

12. The apparatus of claim 11 further comprising:
(a) an input device enabling a user input a sex datum and a birth date datum;
(b) another program instruction stored in said memory and executable by said processing unit to determine at least one of a favorable and an unfavorable compass direction from said sex datum and said birth date datum;
(c) a display for presenting at least one of a favorable and an unfavorable compass direction to a user.

13. The apparatus of claim 11 further comprising:
(a) a gyroscope outputting a direction datum in response to movement of said apparatus;
(b) an input device enabling a user to input an initiation of movement datum and a termination of movement datum; and
(c) another program instruction stored in said memory and executable by said processing unit to determine from said direction datum and said first and said second acceleration data a displacement of said apparatus between input of said initiation of movement datum and input of said termination of movement datum.

14. The apparatus of claim 13 further comprising an additional program instruction stored in said memory and executable by said processing unit enabling said processing unit to determine an area of bounded by a displacement of said apparatus.

15. The apparatus of claim 13 further comprising:
(a) a receiver of a global positioning signal;
(b) another program instruction stored in said memory and executable by said processing unit to determine a position of said apparatus from said global position signal; and
(c) an additional program instruction stored in said memory and executable by said processing unit enabling said processing unit to alter said determination of said displacement of said apparatus in response to said determination of said position of said apparatus.

16. The apparatus of claim 11 further comprising:
(a) a gyroscope outputting a direction datum in response to movement of said apparatus;
(b) an input device enabling a user to input an initiation of movement datum and a termination of movement datum; and
(c) a program instruction executable by said processing unit to determine from said direction datum, said first and said second acceleration data, and at least one of said first, said second, and said third magnetic field data a displacement of said apparatus between input of said initiation of movement datum and input of said termination of movement datum.

17. The apparatus of claim 16 further comprising an additional program instruction stored in said memory and executable by said processing unit enabling said processing unit to determine an area of bounded by a displacement of said apparatus.

18. The apparatus of claim 16 further comprising:
(a) a receiver of a global positioning signal;
(b) another program instruction stored in said memory and executable by said processing unit to determine a position of said apparatus from said global position signal; and
(c) an additional program instruction stored in said memory and executable by said processing unit enabling said processing unit to alter said determination of said displacement of said apparatus in response to said determination of said position of said apparatus.

19. The apparatus of claim 18 further comprising an additional program instruction stored in said memory and executable by said processing unit enabling said processing unit to determine an area of bounded by a displacement of said apparatus.
